(19) United States
(12) Patent Application Publication
(10) Pub. No.: US 2017/0021876 A1
(43) Pub. Date: Jan. 26, 2017

(54) SPARE WHEEL MOUNTING SYSTEM

(71) Applicant: GM GLOBAL TECHNOLOGY OPERATIONS LLC, Detroit, MI (US)

(72) Inventors: Reginaldo Alves Silva, Sao Paulo (BR); Fabio D. Rocha, Sao Caetano do Sul (BR)

(73) Assignee: GM GLOBAL TECHNOLOGY OPERATIONS LLC, Detroit, MI (US)

(21) Appl. No.: 14/808,484

(22) Filed: Jul. 24, 2015

(51) Int. Cl. B62D 43/02; B62D 43/00

(52) U.S. Cl. CPC B62D 43/02; B62D 43/007

(57) ABSTRACT

A mounting system for a wheel having a center portion with a plurality of wheel apertures includes a cap for covering the center portion of the wheel and having a pocket. The system includes a first fastener having a shank that fits through at least one of the wheel apertures. The shank has a first end, a second end, and a head at the first end configured to be captured by the cap pocket. The first fastener also includes a nut configured to thread onto the second end. The system also includes a second fastener having a shank that fits through at least one of the wheel apertures. The system additionally includes a wheel carrier bracket defining a plurality of bracket apertures, wherein the second fastener is configured to be threadably engaged with at least one of the bracket apertures. A vehicle having such a mounting system is also disclosed.

### TECHNICAL FIELD

The present disclosure relates to a mounting system for a vehicle spare wheel or a spare wheel and tire assembly.

### BACKGROUND

A spare tire is an additional tire typically carried in a motor vehicle as a replacement for a flat, a blow-out, or other road tire emergency. The term “spare tire” is generally a misnomer, as almost all vehicles actually carry an entire wheel with a tire mounted thereon as a spare, such that a full wheel and tire assembly can be ready for an emergency retrofit. Although some spare tires are configured as “limited use” space-savers that are not meant to be driven for long distances or at high speeds, many contemporary vehicles come equipped with full-size spares, i.e., identical in type and size to road wheels fitted to the vehicle.

Among passenger vehicles, full-size spare tires are usually provided for vehicles with higher centers of gravity, such as sport utility vehicles (SUVs) and light trucks. Due to the size of the flat-sized spare tire, it is often mounted on the outside of the vehicle. On some light trucks, the spare tire is stored beneath the truck bed. Many SUVs and off-road vehicles have the spare tire mounted externally—usually on the rear door, but others may mount them on the roof, the side, or even on the vehicle hood.

### SUMMARY

A mounting system for a wheel having a center portion defining a plurality of wheel apertures includes a cap configured to cover the center portion of the wheel, including the plurality of wheel apertures, and having a pocket. The mounting system includes a first fastener having a shank configured to fit through each of the wheel apertures. The shank is additionally defined by a first end, a second end, and a head arranged at the first end. The head is configured to be captured by the pocket of the cap. The first fastener also includes a nut configured to thread onto the second end. The mounting system also includes a second fastener having a shank configured to fit through each of the wheel apertures. The mounting system additionally includes a wheel carrier bracket defining a plurality of bracket apertures, wherein the second fastener is configured to be threadably engaged with at least one of the bracket apertures.

The cap may include a plurality of clips configured to secure the cap to the center portion of the wheel.

The pocket and the plurality of clips may each be integrally formed with the cap.

The shank of the first fastener may be defined by a predetermined length configured to extend through one of the plurality of wheel apertures and one of the plurality of bracket apertures. In such a case, the second end may extend past the wheel and the wheel carrier bracket, and the nut may be threaded onto the second end to secure the wheel to the wheel carrier bracket.

The first fastener may have a feature configured to restrict the first fastener from rotating relative to the cap.

The wheel carrier bracket may be mounted to a body structure of a vehicle.

The wheel carrier bracket may be selectively locked in place and repositioned relative to the body structure of the vehicle.

The body structure of the vehicle may include a tailgate, and the wheel carrier bracket may be configured to pivot relative to the tailgate to thereby be repositioned relative to the vehicle.

A vehicle having the disclosed mounting system for a wheel is also provided. The wheel may include a spare tire mounted thereon. The mounting system may be used to minimize the possibility of theft of the wheel and tire assembly externally mounted on the vehicle.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a perspective rear view of a vehicle with an exterior mounted spare wheel and tire assembly via a mounting system according to the disclosure.

FIG. 2 is a perspective exploded view of the mounting system partially shown in FIG. 1 according to the disclosure.

FIG. 3 is an inside perspective view of a cap used in the mounting system shown in FIG. 2.

FIG. 4 is a schematic cross-sectional view of the first fastener, shown in FIG. 2, seated within a pocket of the cap according to the disclosure.

### DETAILED DESCRIPTION

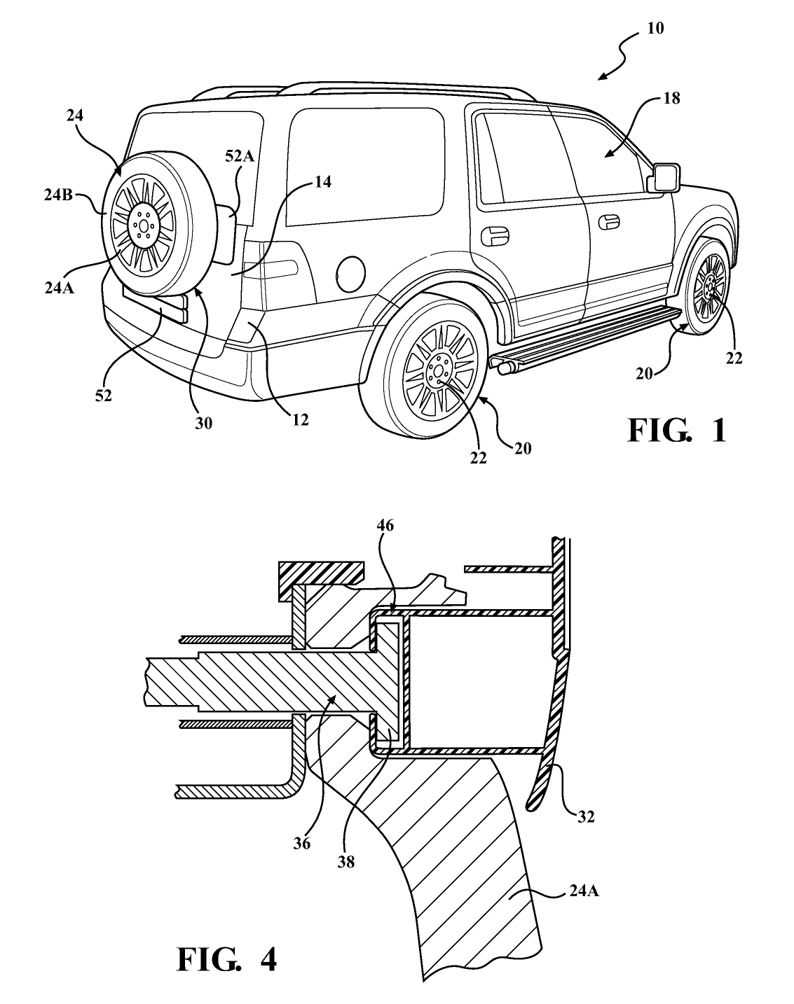

Referring to the drawings, wherein like reference numbers refer to like components, FIGS. 1-4 show a perspective rear view of a vehicle 10 having a body structure 12. As shown, the body structure 12 includes a rear door or tailgate 14 that can be used for access to a cargo area 16 and/or a passenger compartment 18 of the vehicle 10. Although the vehicle 10 may have any body style configuration, for exemplary purposes the vehicle is illustrated as a sport utility vehicle (SUV). The vehicle 10 includes road-wheel-and-tire assemblies 20 attached to the vehicle via a plurality of fasteners 22, such as to a wheel hub that is operatively connected to the vehicle suspension (not shown).

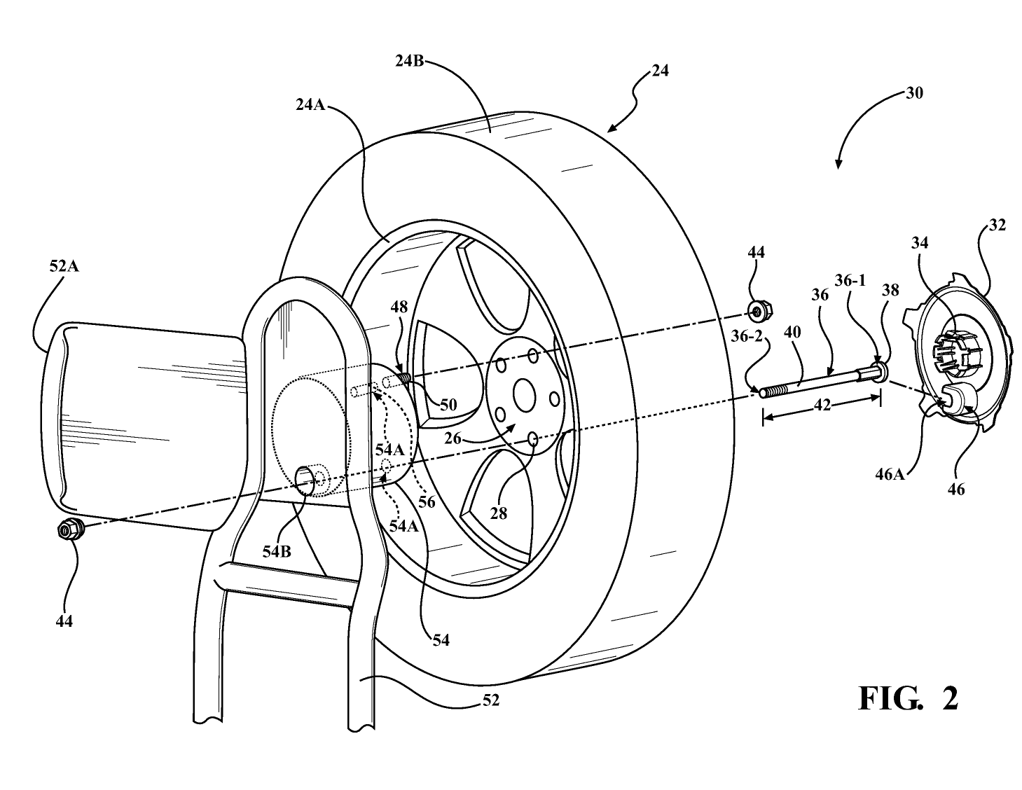

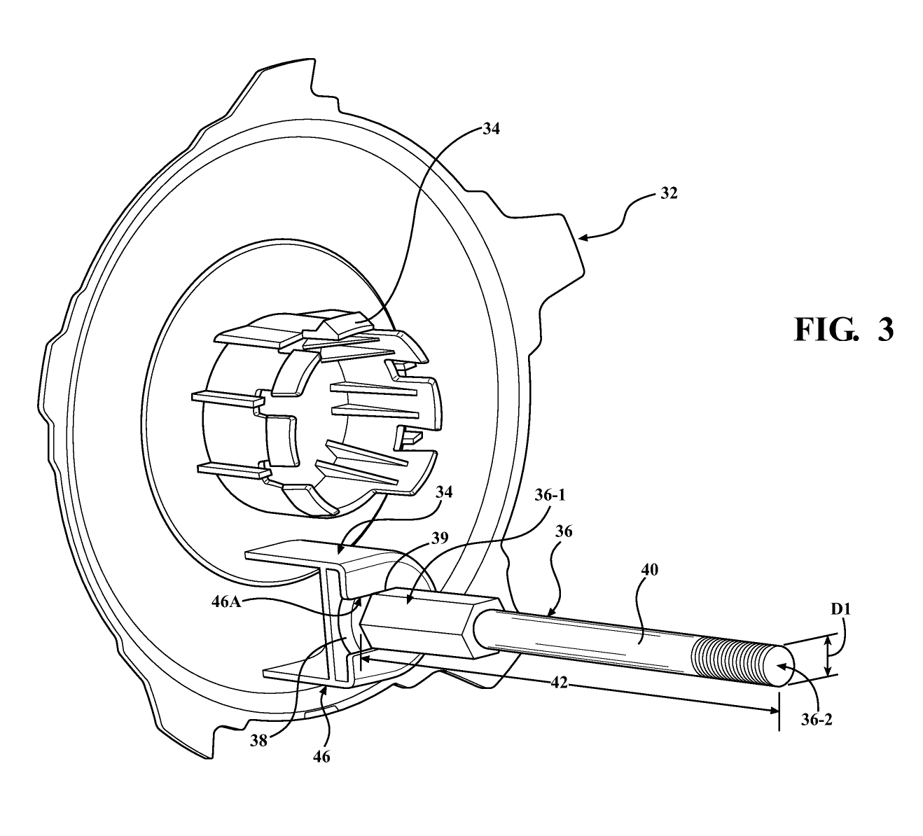

As shown in FIGS. 1 and 2, the vehicle 10 also includes a spare wheel and tire assembly 24 mounted to the body structure 12. Specifically, the spare wheel and tire assembly 24 can be mounted to the tailgate 14. As shown, the spare wheel and tire assembly 24 includes a wheel 24A and a tire 24B mounted thereon. As can be seen in FIG. 3, the wheel 24A includes a center portion 26 defining a plurality of wheel apertures 28. Generally, a wheel for a typical vehicle, such as the vehicle 10, has between three and six wheel apertures 28. Each of the apertures 28 is configured to accept one of the fasteners 22 for securing the wheel 24A to the vehicle 10 in place of and in the event any of the road-wheel-and-tire assemblies 20 experiences a failure, such as a blowout of the respective tire. The spare wheel and tire assembly 24 is mounted to the body structure 12 via a mounting system 30. The mounting system 30 includes a cap 32 that is configured to be attached to the wheel 24A in order to cover the center portion 26, including the plurality of wheel apertures 28. The wheel apertures 28 can have a substantially same diameter, i.e., within a manufacturing tolerance specified by a manufacturer of the wheel 24A. The cap 32 can include a plurality of clips 34 configured to fix the cap to the wheel 24A by fitting and snapping into or at the center portion 26, and securing the cap thereto. The cap 32 can be formed from a suitable polymer and each of the clips 34 can be integrally formed therewith.

As shown in FIGS. 2-4, the mounting system 30 also includes a first fastener 36. The first fastener 36 is distinct from any of the fasteners 22 regularly used to attach the road-wheel-and-tire assemblies 20 to the vehicle 10. Specifically, the first fastener 36 has a first end 36-1 and a second end 36-2. A head 38 is arranged at the first end 36-1, while a shank 40 extends between the head 36 and the second end 36-2. The shank 40 is defined by a length 42 and is configured to fit through at least one of the apertures 28, or, if all the apertures 28 have the same diameter, the shank 40 will fit through any of the apertures. Specifically, the shank 40 has a diameter D1 that is smaller than respective diameters of the wheel apertures 28. As specifically shown in FIG. 2, the mounting system 30 also includes a nut 44 configured to thread onto the second end 36-2.

The cap 32 also includes a pocket 46. The head 38 of the first fastener 36 has a shape that permits the head to seat in, be captured and retained by the pocket 46 of the cap 32 when the first fastener is inserted into one of the apertures 28 and the cap is attached to the wheel 24A. As shown, the pocket 46 may include a slot 46A that permits the head 38 to be inserted into and become engaged with the pocket. Additionally, the first fastener 36 may include a feature 39 configured to restrict rotation of the first fastener relative to the cap 32 as the nut 44 is threaded onto the second end 36-2 and tightened. The feature 39 may be formed as a projection or a flat surface on the shank 40 to check and stop rotation of the first fastener 36 relative to the cap 32. The feature 39 may also be a specific shape or contour of the head 38 (not shown), for example a square or some other non-round shape, such that the first fastener 36 is restricted by the inner shape of the pocket 46 from rotating relative to the cap 32. Similar to the clips 34, the pocket 46 can be integrally formed with the cap 32. As specifically shown in FIG. 2, the mounting system 30 also includes a second fastener 48 having a shank 50 configured to fit through at least one or through each and any aperture 28. As shown, the mounting system 30 may include a plurality of second fasteners 48. Although the second fastener 48 is shown as an embedded stud to be used with a nut similar to the nut 44, the second fastener may also be configured as a bolt.

As shown in FIGS. 1 and 2, a wheel carrier bracket 52 is mounted to the body structure 12 of the vehicle 10. The wheel carrier bracket 52 has a portion 54 that defines a plurality of bracket apertures 54A. The bracket apertures 54A may have an internal thread 56 such that the second fastener 48 can be threadably engaged with any of the bracket apertures. The length 42 of the first fastener's shank 40 is configured to extend through both, one of the plurality of wheel apertures 28 and one of the plurality of bracket apertures 54A. When the first fastener 36 is inserted through each of the wheel aperture 28 and the bracket aperture 54A, the second end 36-2 extends past each of the wheel 24A and the wheel carrier bracket 52, such that the nut 44 can be threaded onto the second end to secure the wheel 24A to the wheel carrier bracket. The portion 54 may include a receptacle 54B to accommodate the nut 44 therein when the nut is tightened on the first fastener 36. One or more of the bracket apertures 54 may have a shape with at least one flat side, such as square, for interacting with the feature 39 on the first fastener 36 to restrict rotation of the first fastener relative to the cap 32 as the nut 44 is tightened.

The wheel carrier bracket 52 is mounted to the body structure 12 such that the wheel carrier bracket can be selectively locked in place on the vehicle 10 so that access to the nut 44 is restricted. As shown, the wheel carrier bracket 52 is also configured to be selectively repositioned relative to the body structure 12 of the vehicle 10 in order to gain access to the nut 44 for removing the wheel 24A from the vehicle. For example, the wheel carrier bracket 52 can be constructed to pivot relative to the tailgate 14 and thereby swung relative to the vehicle 10 to permit access to the nut 44 when the wheel is attached to the wheel carrier bracket 52. A handle 52A can be provided for an operator of the mounting system 30 for pivoting the wheel carrier bracket 52 relative to the vehicle 10.

With particular reference to FIG. 3, during mounting of the wheel 24A or the spare wheel and tire assembly 24 onto the vehicle 10 via the mounting system 30, the wheel 24A may first be attached to the wheel carrier bracket 52. The attachment of the wheel 24A to the wheel carrier bracket 52 may be initiated with the head 38 of the first fastener 36 being captured by the pocket 46 of the cap 32. Then, the shank 50 of the second fastener(s) 48 can be inserted through one of the apertures 28, into one of the bracket apertures 54A and tightened therein, if the second fastener is a bolt. Also, another fastener largely identical to the second fastener 48 can be similarly inserted through another aperture 28, threaded into another one of the bracket apertures 54A, and can be tightened therein. Accordingly, two fasteners 48 will then be secured and holding the wheel 24A on the wheel carrier bracket 52. In the event that any of the second fasteners 48 are studs (as shown in FIG. 2), the second fastener(s) will likely already be fixed on the portion 54, and the nut(s), such as the nut 44, can be tightened on the second fastener(s) against the center portion 26 of the wheel 24A.

Following at least one second fastener 48 being secured at the center portion 26 of the wheel 24A, the shank 40 of the first fastener 36 can then be inserted through one of each of the remaining empty wheel apertures 28 and one of the remaining empty bracket apertures 54A. The nut 44 can be threaded onto the second end 36-2 of the first fastener 36 and tightened after the second end has extended past the wheel carrier bracket 52. As the nut 44 is tightened, or prior to such, the clips 34 of the cap 32 can snap into the center portion 26 and secure the cap to the wheel 24A. Following such mounting of the wheel 24A onto the wheel carrier bracket 52, the wheel carrier bracket can be swung to a position relative to the vehicle body structure that restricts access to the nut 44.

Following the above procedure, the wheel carrier bracket 52 can be locked in place, for example to the tailgate 14, in order to facilitate secure retention of the wheel 24A on the vehicle 10. Unlocking of the wheel carrier bracket 52 to gain access to the nut 44 may be performed by an authorized operator of the mounting system 30 via a key, a remote device from outside the vehicle 10, or via a switch from the passenger compartment 18. Accordingly, the mounting system 30 can be used to thwart unauthorized removal of the spare wheel and tire assembly 24 from the vehicle 10, i.e., serve as an anti-theft mounting system for the externally mounted wheel and tire assembly.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A mounting system for a wheel having a center portion defining a plurality of wheel apertures, the mounting system comprising:
a cap configured to cover the center portion of the wheel and having a pocket;
a first fastener having a shank configured to fit through at least one of the plurality of wheel apertures, a first end, a second end, and a head arranged at the first end and configured to be captured by the pocket of the cap;
a nut configured to thread onto the second end of the first fastener;
a second fastener having a shank configured to fit through at least one of the plurality of wheel apertures; and
a wheel carrier bracket defining a plurality of bracket apertures, wherein the second fastener is configured to be threadably engaged with at least one of the bracket apertures.

2. The mounting system of claim 1, wherein the cap includes a plurality of clips configured to secure the cap to the center portion of the wheel.

3. The mounting system of claim 2, wherein the pocket and the plurality of clips are each integrally formed with the cap.

4. The mounting system of claim 1, wherein the shank of the first fastener is defined by a predetermined length configured to extend through one of the plurality of wheel apertures and one of the plurality of bracket apertures, such that the second end extends past each of the wheel and the wheel carrier bracket and the nut is threaded onto the second end to secure the wheel to the wheel carrier bracket.

5. The mounting system of claim 1, wherein the first fastener includes a feature configured to restrict the first fastener from rotating relative to the cap.

6. The mounting system of claim 1, wherein the wheel carrier bracket is mounted to a body structure of a vehicle.

7. The mounting system of claim 6, wherein the wheel carrier bracket is configured to be selectively locked in place and repositioned relative to the body structure of the vehicle.

8. The mounting system of claim 7, wherein the body structure of the vehicle includes a tailgate, and wherein the wheel carrier bracket is configured to pivot relative to the tailgate to thereby be repositioned relative to the vehicle.

9. A vehicle comprising:
a vehicle body structure; and
a mounting system for a spare tire mounted on a wheel having a center portion defining a plurality of wheel apertures, wherein the mounting system is configured to secure the wheel to the vehicle body structure and includes:
a cap configured to cover the center portion of the wheel and having a pocket;
a first fastener having a shank configured to fit through at least one of the plurality of wheel apertures, a first end, a second end, and a head arranged at the first end and configured to be captured by the pocket of the cap;
a nut configured to thread onto the second end of the first fastener;
a second fastener having a shank configured to fit through at least one of the plurality of wheel apertures; and
a wheel carrier bracket mounted to the vehicle body structure and defining a plurality of bracket apertures, wherein the second fastener is configured to be threadably engaged with at least one of the bracket apertures.

10. The vehicle of claim 9, wherein the cap includes a plurality of clips configured to secure the cap to the center portion of the wheel.

11. The vehicle of claim 10, wherein the pocket and the plurality of clips are each integrally formed with the cap.

12. The vehicle of claim 9, wherein the shank of the first fastener is defined by a predetermined length configured to extend through one of the plurality of wheel apertures and one of the plurality of bracket apertures, such that the second end extends past each of the wheel and the wheel carrier bracket and the nut is threaded onto the second end to secure the wheel to the wheel carrier bracket.

13. The vehicle of claim 9, wherein the first fastener includes a feature configured to restrict the first fastener from rotating relative to the cap.

14. The vehicle of claim 9, wherein the wheel carrier bracket is configured to be selectively locked in place and repositioned relative to the body structure of the vehicle.

15. The vehicle of claim 14, wherein the body structure of the vehicle includes a tailgate, and wherein the wheel carrier bracket is configured to pivot relative to the tailgate to thereby be repositioned relative to the vehicle.

16. A vehicle comprising:
a vehicle body structure including a tailgate; and
an anti-theft mounting system for a spare tire mounted on a wheel having a center portion defining a plurality of wheel apertures, wherein the anti-theft mounting system is configured to secure the wheel to the vehicle body structure and includes:
a cap configured to cover the center portion of the wheel and having a pocket;
a first fastener having a shank configured to fit through at least one of the plurality of wheel apertures, a first end, a second end, and a head arranged at the first end and configured to be captured by the pocket of the cap;
a nut configured to thread onto the second end of the first fastener;
a second fastener having a shank configured to fit through at least one of the plurality of wheel apertures; and
a wheel carrier bracket mounted to the vehicle body structure, configured to pivot relative to the tailgate to thereby be repositioned relative to the vehicle, and defining a plurality of bracket apertures, wherein the second fastener is configured to be threadably engaged with at least one of the bracket apertures.

17. The vehicle of claim 16, wherein the cap includes a plurality of clips configured to secure the cap to the center portion of the wheel.

18. The vehicle of claim 17, wherein the pocket and the plurality of clips are each integrally formed with the cap.

19. The vehicle of claim 16, wherein the shank of the first fastener is defined by a predetermined length configured to extend through one of the plurality of wheel apertures and one of the plurality of bracket apertures, such that the second end extends past each of the wheel and the wheel carrier bracket and the nut is threaded onto the second end to secure the wheel to the wheel carrier bracket.

20. The vehicle of claim 16, wherein the first fastener includes a feature configured to restrict the first fastener from rotating relative to the cap.
